(19) United States
(12) Patent Application Publication
(10) Pub. No.: US 2012/0180880 A1
(43) Pub. Date: Jul. 19, 2012

(54) DUAL PLATE WAFER CHECK VALVE

(75) Inventors: Robert S. Pettit, Norman, OK (US); Omkar A. Solapurkar, Oklahoma City, OK (US); John M. Saldivar, Richmond, TX (US)

(73) Assignee: CAMERON INTERNATIONAL CORPORATION, Houston, TX (US)

(21) Appl. No.: 13/009,472

(22) Filed: Jan. 19, 2011

(51) Int. Cl. F16K 15/00

(52) U.S. Cl. 137/511

(57) ABSTRACT

A check valve including a housing comprising a fluid passage along a housing axis, a check valve cartridge disposed in the fluid passage, and a retainer that limits axial movement of the check valve cartridge in the fluid passage, wherein the retainer allows rotational movement of the check valve cartridge.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Check valves are capable of protecting mechanical equipment by preventing the reversal of flow through a conduit. That is, the check valve is capable of allowing the passage of a fluid (i.e., liquid or gas) in one direction through the conduit (e.g., forward flow) and stopping the flow of the fluid through the conduit in the opposite direction (e.g., backward flow). Unfortunately, some check valves may involve complex machining of the housing for insertion and may be difficult to remove.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is an axial cross-section of an embodiment of a check valve illustrating open and closed positions;

FIG. 2 is an exploded axial cross-section of an embodiment of the check valve of FIG. 1 with an annular support, check valve element assembly, and retainer;

FIG. 3 is an exploded rear perspective view of the check valve of FIG. 1;

FIG. 4 illustrates a partially exploded rear perspective view of the check valve of FIG. 1;

FIG. 5 is a partially rear perspective view of an embodiment of a mounting groove in an annular support taken within line 5-5 of FIG. 4;

FIG. 6 is a perspective view of an embodiment of a mounting insert;

FIG. 7 is a rear perspective view of an embodiment of a retainer being inserted into the check valve of FIG. 1;

FIG. 8 is a rear perspective view of an embodiment of the check valve of FIG. 1;

FIG. 9 is a front perspective view of an embodiment of the check valve of FIG. 1;

FIG. 10 is a sectional view within line 10-10 of FIG. 1 illustrating an embodiment of a seal interface between the housing and the annular support;

FIG. 11 is a sectional view within line 10-10 of FIG. 1 illustrating another embodiment of a seal interface between the housing and the annular support;

FIG. 12 is a sectional view within line 12-12 of FIG. 1 illustrating a gasket aperture on an annular support;

FIG. 13 is a sectional view within line 12-12 of FIG. 1 illustrating another gasket aperture on an annular support;

FIG. 14 is a sectional view within line 12-12 of FIG. 1 illustrating another gasket aperture on an annular support;

FIG. 15 is a sectional view within line 15-15 of FIG. 1 illustrating an embodiment of the retainer that axially holds the cartridge in the housing; and

FIG. 16 is a sectional view within line 15-15 of FIG. 1 illustrating another embodiment of the retainer that axially holds the cartridge in the housing.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components.

As discussed below, the disclosed embodiments include a check valve, which has a check valve cartridge and a retainer that holds the check valve cartridge in a housing. Advantageously, the check valve cartridge may be installed and removed in its entirety, enabling rapid replacement as well as removal for operations such as pigging. In other words, the check valve cartridge includes a check valve element coupled to a support, such that the check valve element is self-retained to the support rather than the housing. Thus, the check valve element opens and closes relative to the support, which may be removably mounted and sealed to the housing. Furthermore, the check valve cartridge is advantageously mounted and held in place without threaded fasteners, allowing for tool less removal and installation. In addition, the absence of threaded fasteners advantageously reduces the machining complexity of the check valve. Furthermore, the check valve cartridge is mounted in the housing without any external mounting hardware (e.g., fasteners) extending completely through the housing (e.g., a potential leak path), thereby reducing the possibility of leaking through the housing.

FIG. 1 is an axial cross-section of an embodiment of a check valve 10 illustrating open and closed positions. In the following discussion, reference may be made to an axial direction axis 4, a radial direction or axis 6, and a circumferential direction or axis 8 to explain the assembly on operation of the check valve 10. Thus, a legend with these axes 4, 6, and 8 is illustrated in FIGS. 1-5 and 7-9. The check valve includes a housing 12, a check valve cartridge 14, and a retainer 16. As illustrated, the housing 12 defines a fluid passage 18 along a housing axis 20. It is along this fluid passage 18 that a fluid may flow through the check valve cartridge 14. The fluid may be a gas, a liquid, or a combination thereof. An inner surface 22 of the housing 12 defines the boundaries of the fluid passage 18.

The inner surface 22 defines a retainer aperture 24, a seal aperture 26, and inner lip 27. The inner lip 27 defines an annular seat contact surface 28. As illustrated, the seal aperture 26 includes a seal or gasket 29 (e.g., o-ring), which creates a fluid tight seal between the check valve cartridge 14 and the housing 12. The gasket 29 may be formed out of a variety of materials including an elastomer, a polymer, a metal, a fabric, a rubber, or a combination thereof.

The retainer 16 likewise fits within the housing 12, specifically within retainer aperture 24. In certain embodiments, the retainer 16 may be a c-clip or a ring, which radially compresses during insertion and then expands into the retainer aperture 24. Once within the aperture 24, the retainer 16 in combination with the annular seat contact surface 28 lock the check valve cartridge 14 within the housing 12 (i.e., limit axial movement of the check valve cartridge 14). This arrangement advantageously retains the check valve cartridge 14 within the housing 12 without threaded fasteners (e.g., bolts). Accordingly, because there are no threaded fasteners the check valve cartridge 14 may rotate within the housing 12 between the retainer 16 and the annular seat contact surface 28. The rotation of the check valve cartridge 14 may therefore advantageously limit turbulent flow through the check valve 10 as the check valve cartridge 14 aligns with the flow passing through fluid passage 18.

As illustrated, the housing 12 includes an outer surface 30. The outer surface 30 defines a first conduit mating face 32, a second conduit mating face 34, and an annular groove 36. The annular groove 36 may permit insertion of fasteners (e.g., bolts) through the conduit mating faces 32 and 34, thus permitting fasteners to connect the housing 12 to conduits.

The check valve cartridge 14 includes an annular support 38 and a check valve element assembly 40. In particular, the check valve element assembly 40 couples to the annular support 38 instead of the housing 12. The check valve assembly 40 includes springs 42 and check valve elements 44. As illustrated, the check valve elements 44 (e.g., plates) are able to rotate from a closed position (solid lines) to an open position (dashed lines) as fluid travels in the direction 46 through the fluid passage 18. Specifically, when fluid pressure overcomes the force of the springs 42, the elements 44 rotate open allowing fluid to flow through the check valve 10. Once fluid pressure falls below a threshold value, the springs 42 return the elements 44 to a closed position preventing the back flow of fluid through the check valve 10.

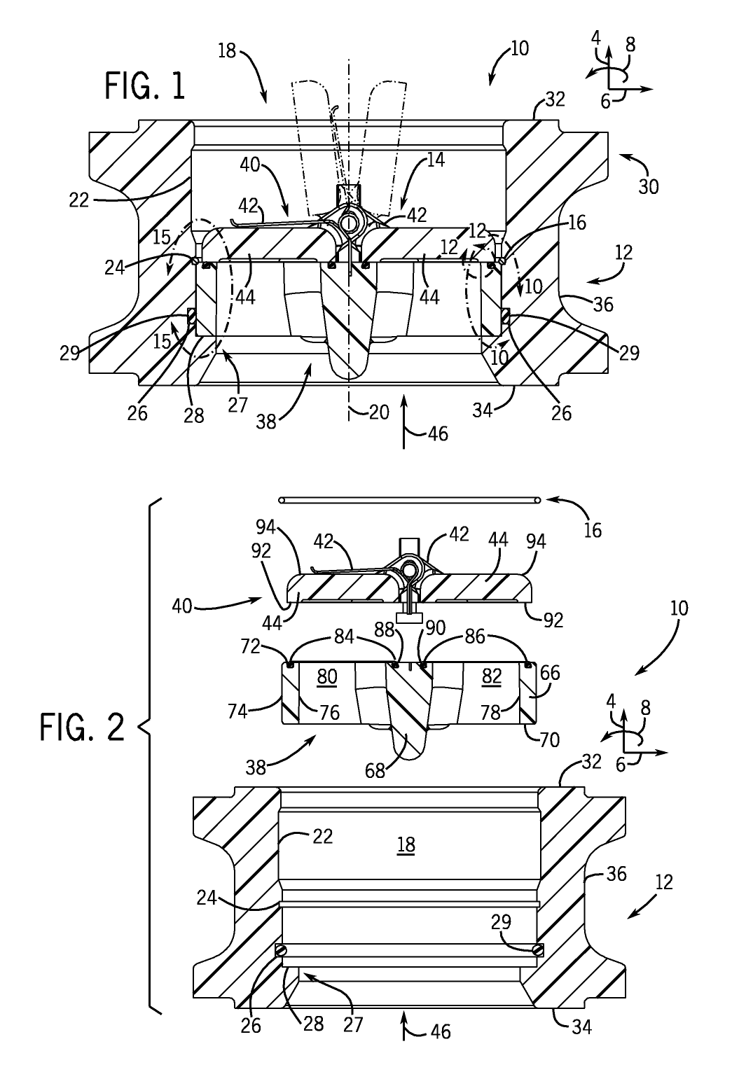

FIG. 2 is an exploded axial cross-section of an embodiment of the check valve of FIG. 1. As illustrated, the annular support 38 and check valve element assembly 40 are not yet assembled and placed within the housing 12 with the retainer 16. The annular support 38 includes an annular seat 66, a center body 68, a front face 70, a rear face 72, outer surface 74, and inner surfaces 76 and 78. As illustrated, the center body 68 divides the annular seat 66 into two apertures 80 and 82 and protrudes axially beyond the front face 70. While only two apertures 80 and 82 are illustrated, other embodiments may include more apertures (e.g., 1, 2, 3, 4, 5, 6, or more apertures). Furthermore, the center body 68 may form a variety of shapes. In certain embodiments, the center body 68 may have an airfoil shape, a conical shape, a wedge shape, a diverging shape, a rectangular shape, or another suitable geometry. For example, the center body 68 may form an aerodynamic shape that causes the annular support 38 to rotate as fluid passes through the cartridge 14. As mentioned above, the rotatability of the annular support 38 may reduce fluid turbulence, and reduced fluid turbulence may reduce wear on check valve 10 components.

The front face 70 and outer surface 74 of the annular support 38 creates a seal between the annular support 38 and the housing 12. In particular, the front face 70 contacts the annular seat contact surface 28, while the outer surface 74 contacts the gasket 29. Accordingly, fluid traveling through the fluid passage 18 passes through the apertures 80 and 82 and not around the annular support 38. Furthermore, the rear face 72 defines two semi-annular gasket apertures 84 and 86, which support respective gaskets 88 and 90. The gaskets 88 and 90 may be formed out of a variety of materials including an elastomer, a polymer, a metal, a fabric, a rubber, or a combination thereof.

As discussed above, the check valve element assembly 40 connects to the annular support 38 and includes check valve elements 44. The check valve elements 44 define a front face 92 and a rear face 94. When the check valve elements 44 are in the closed position, the front face 92 contacts the rear face 72 of the annular support 38. In particular, the front face 92 of the elements 44 contact a respective gasket 88 and 90. The contact between the elements 44 and the gaskets 88 and 90 creates a fluid tight seal, thus blocking the back flow of fluid through the check valve 10.

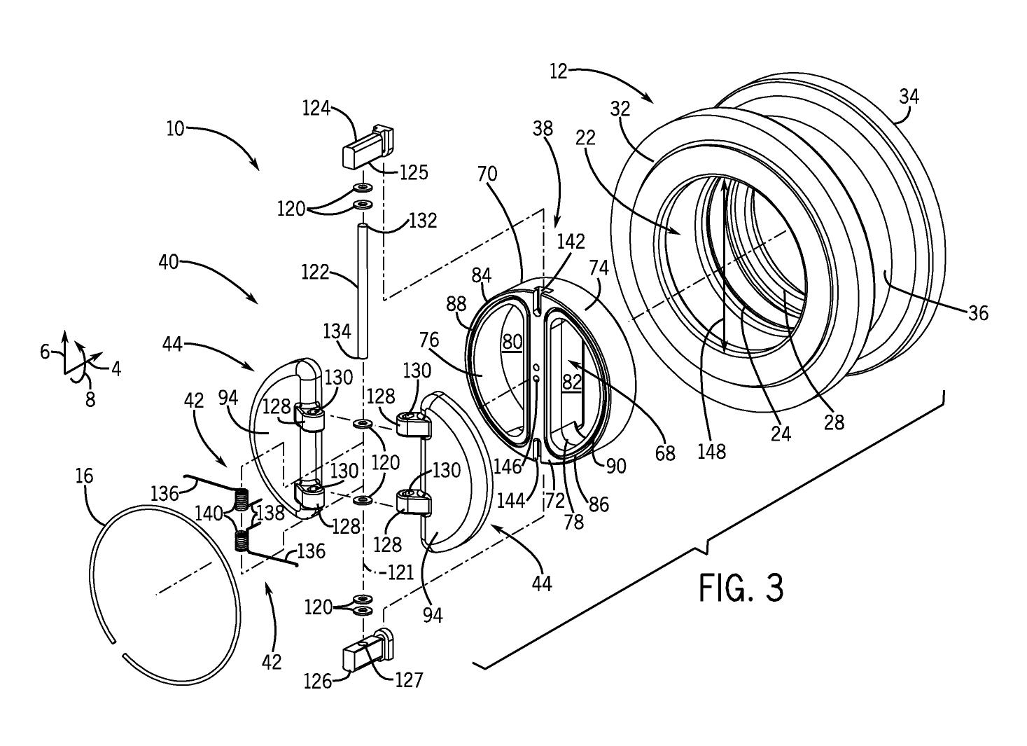

FIG. 3 is an exploded rear perspective view of the check valve 10 of FIG. 1. As illustrated, the check valve assembly 40 includes springs 42, check valve elements 44, washers 120, hinge shaft 122, a first mounting insert 124, and a second mounting insert 126. In the illustrated embodiment, the check valve elements 44 include hinges 128. In particular, each check valve element 44 includes two hinges 128. In other embodiments the check valve elements 44 may include any number of hinges 128 (e.g., 1, 2, 3, 4, 5, 6, or more hinges 128). The hinges 128 include apertures 130 sized to receive hinge shaft 122. Accordingly, the hinge shaft 122 may be inserted through the apertures 130 in the hinges 128 to secure the check valve elements 44 to one another, while allowing the check valve elements 44 to rotate about an axis 121 (i.e., the hinge shaft 122) when opening and closing. The hinge shaft 122 defines a first end 132 and a second end 134. As will be explained in further detail, the first end 132 is rotatably supported by an aperture 125 in the first mounting insert 124, while an aperture 127 in the second mounting insert 126 rotatably supports the second end 134.

The illustrated springs 42 include three sections: a long arm 136, a short arm 138, and a coil section 140. During operation, the fluid flow causes the elements 44 to rotate about the hinge shaft 122 into an open position. When the fluid pressure decreases, the springs 42 apply pressure on the elements 44 returning them to a closed position. In particular, each long arm 136 applies pressure on a respective rear face 94 causing the element 44 to close.

Assembly of the check valve assembly 40 occurs by passing the hinge shaft 122 through the aperture 130 of the hinges 128, washers 120, spring coils 140, and then connecting the first and second mounting inserts 124 and 126 to the respective ends 132, 134 of the hinge shaft 122. Once assembled, the check valve assembly 40 may connect to the annular support 38. In particular, the first and second mounting inserts 124 and 126 mate with first and second mounting grooves 142 and 144 on the annular support 38. Thus, by inserting the mounting inserts 124 and 126 into the mounting grooves 142 and 144, the check valve assembly 40 connects to the annular support 38. Furthermore, during assembly, the short arms 138 of the springs 140 are inserted into apertures 146 on the center body 68. The insertion of short arms 138 in apertures 146 secures the springs 140 to the annular support 38, ensuring independent loading of the springs 140 thus allowing either tandem or individual operation of the elements 44.

As illustrated, the mounting inserts 124 and 126 slide into the grooves 142 and 144 radially toward one another to capture the shaft 122, thereby securing the check valve assembly 40 to the annular support 38. The mounting inserts 124 and 126 may include or exclude fasteners, such as retainer pins, threaded fasteners, adhesives, or clamps. For example, instead of fastening the mounting inserts 124 and 126 onto the annular support 38, the inner surface 22 of the housing 12 may block removal of the inserts 124 and 126 from the support 38. More specifically, the housing 12 defines an inner diameter 148 substantially the same as an outer diameter of the support 38, such that the mounting inserts 124 and 126 are automatically retained within the mounting grooves 142 and 144 once the annular support 38 is within the housing 12. Accordingly, the housing 12, blocks separation of assembly 40 from the support 38.

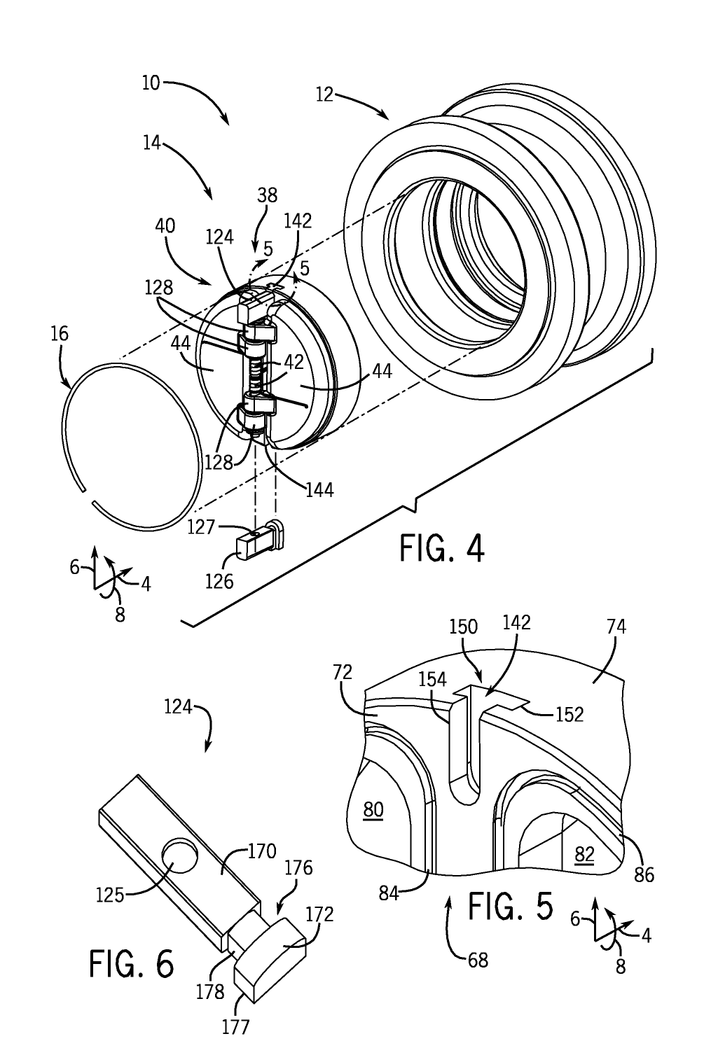

FIG. 4 illustrates a partially exploded rear perspective view of the check valve of FIG. 1. As illustrated, the check valve assembly 40 is substantially assembled with the first mounting insert 124 disposed within the mounting groove 142, while the second mounting insert 126 is being installed in the mounting groove 144. In this stage, the elements 44 cover the apertures 80 and 82 and the springs 42 are positioned between the hinges 128 forcing the elements 44 into a closed position. Once the second mounting insert 126 is disposed within the groove 144, the fully assembled check valve cartridge 14 may be placed within the housing 12.

FIG. 5 is a partial rear perspective view of the annular support 38, further illustrating the first mounting groove 142. As illustrated, the first mounting groove 142 defines a T-shape 150 that extends through the outer surface 74 radially 6 into the annular support 38 along the rear face 72. Thus, the first mounting groove 142 includes first and second slots 152 and 154, wherein the first slot 152 is circumferentially 8 wider then the second slot 154 to define the T-shape 150. Furthermore, the first slot 152 is disposed between the front and rear faces 70 and 72, while the second slot 154 extends along (and is open to) the rear face 72. In other embodiments, the mounting groove 142 may form other shapes. For example, the mounting groove 142 may form a dovetail shape, or a half-dovetail shape, among others. In some embodiments, the first mounting groove 142 may form the same shape as the second mounting groove 144. In other embodiments, the first mounting groove 142 may differ in shape from the second mounting groove 144 (e.g., the groove 142 may form a T-shape, while groove 144 forms a dovetail shape). Regardless of the shape, the grooves 142 and 144 receive the respective inserts 124 and 126 and block movement of the inserts 124 and 126 in opposite axial circumferential directions 4 and 8. However, the grooves 142 and 144 block movement of the inserts 124 and 126 only in the inward radial direction 6, while allowing movement in the outward radial direction 6. As noted above, the inserts 124 and 126 are blocked in the outward radial direction 6 by the housing 12 after installation of the check valve assembly 40 in the housing 12.

FIG. 6 is a perspective view of an embodiment of the mounting insert 124 which may be the same as the second mounting insert 126. The insert 124 includes a hinge support portion 170 and a connector portion 172. As illustrated, the hinge support portion 170 defines the aperture 125. The aperture 125 is able to receive either end 132 or 134 of hinge shaft 122. In this manner, the hinge support portion 170 supports and anchors the hinge shaft 122, thus allowing the elements 44 to open and close by rotating about the shaft 122. While the aperture 125 anchors the shaft 122, the connector portion 172 connects to the annular support 38 at the first mounting groove 142. As illustrated, the connector portion 172 defines a T-shape 176. This T-shape 176 corresponds with the T-shape 141 of the groove 142. Thus, during connection, the connector portion 172 is able to slide radially 6 into the groove 142. For example, the T-shape 176 includes a head portion 177 and a neck portion 178, wherein the head portion 177 is wider than the neck portion 178 to define the T-shape 176. Thus, the head portion 177 fits within the first slot 152 of the groove 142, while the neck portion 178 fits within the second slot 154 of the grove 142. In this manner, the head portion 177 is blocked from moving in the axial direction 4, because the head portion 177 is circumferentially 8 wider then the second slot 154. However, the groove 142 and the connector portion 172 may have a variety of shapes that mate with one another to block movement of the insert 124. Furthermore, some embodiments of the insert 124 may include snaps or other retention features.

FIG. 7 is a rear perspective view of an embodiment of the retainer 16 locking the check valve cartridge 14 within the housing 12. After assembling the check valve cartridge 14, the cartridge 14 fits within the housing 12. As explained above, the housing 12 includes the annular lip 27 with the annular seat contact surface 28 that blocks axial 4 movement in the direction of arrow 180. While the annular seat contact surface 28 blocks axial 4 movement in the direction of arrow 180, the cartridge may still move axially in the direction of 182. Accordingly, the retainer 16 follows the cartridge 14 into the housing 12 and locks into the retainer aperture 24, thereby blocking axial 4 movement of the cartridge 14 in the direction of arrow 182.

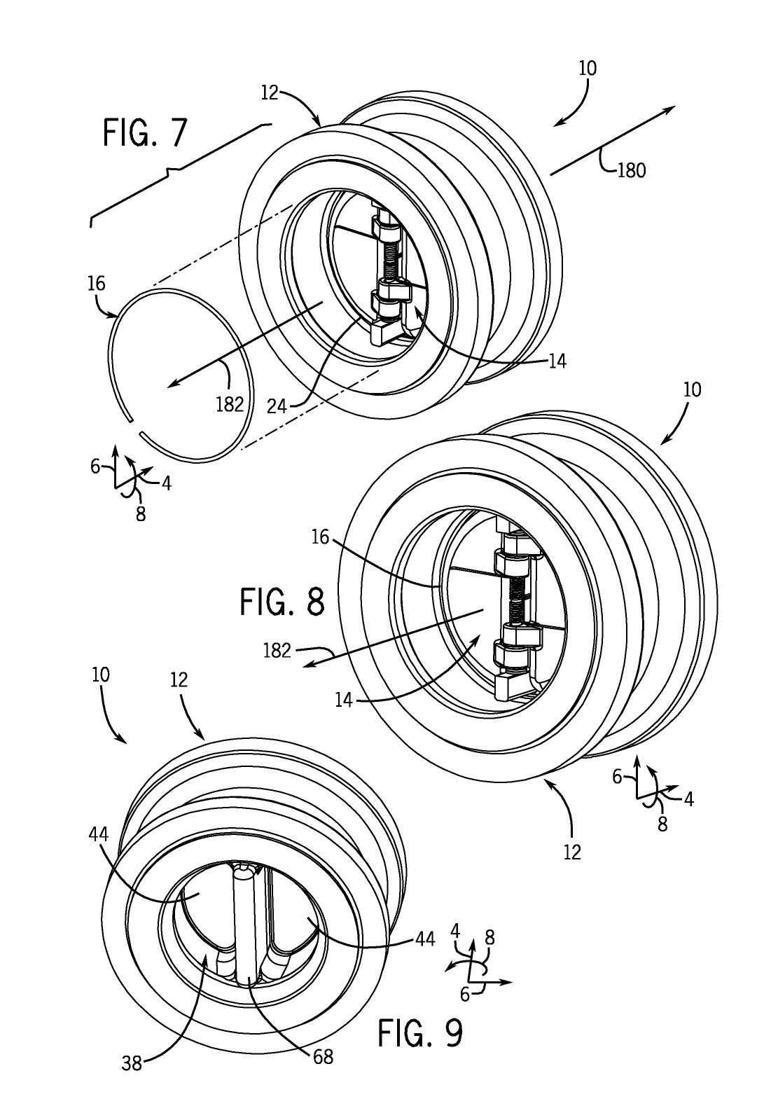

FIG. 8 is a rear perspective view of an embodiment of the check valve 10. As illustrated, the check valve cartridge 14 is disposed within the housing 12 and axially locked in place by the retainer 16. Once the cartridge 14 is within the housing 12 the now assembled check valve 10 permits fluid to flow only in the direction of arrow 182. As explained above, the check valve cartridge 14 advantageously mounts within the housing 12 without any special fasteners, mounts, or machining, thus permitting easy installation, removal, and replacement of the cartridge 14 in a variety of housings 12. For example, the cartridge 14 is not secured to the housing 12 with any threaded fasteners, such as bolts. Furthermore, the components of the cartridge 14 are self-retained to the cartridge 14 rather than the housing 12, such that cartridge 14 may be installed and removed as a single unit. For example, if any of gaskets or components on the check valve cartridge 14 wear out, then the entire cartridge 14 can be easily removed as a single unit, and the entire cartridge 14 may be replaced or serviced before reinstallation as a single unit. The easy removability of the check valve cartridge 14 may also facilitate operations, such as pigging by allowing quick removal and replacement of the cartridge 14. The retainer 16 also enables rotation of the cartridge 14 relative to the housing 12. For example, the cartridge 14 may rotate in response to the fluid flow to self-align with the fluid flow, thereby reducing turbulent flow and stress on the cartridge 14.

FIG. 9 is a front perspective view of an embodiment of the check valve 10. As explained above, the annular support 38 includes the center body 68. The center body 68 may form a variety of shapes, such as an aerodynamic shape. Furthermore, the center body 68 may facilitate rotation of the annular support 38 within the housing 12. The rotation of the annular support 38 helps align the check valve elements 44 within the fluid flow, thus reducing the overall turbulence in the fluid flow and wear on check valve components. For example, if the fluid flow has some amount of swirl in the circumferential direction 8, then the swirl may impact the center body 68 causing rotation of the cartridge 14 alone with the swirl. In other words, the cartridge 14 self-aligns with the fluid flow, e.g., rotates along with swirl.

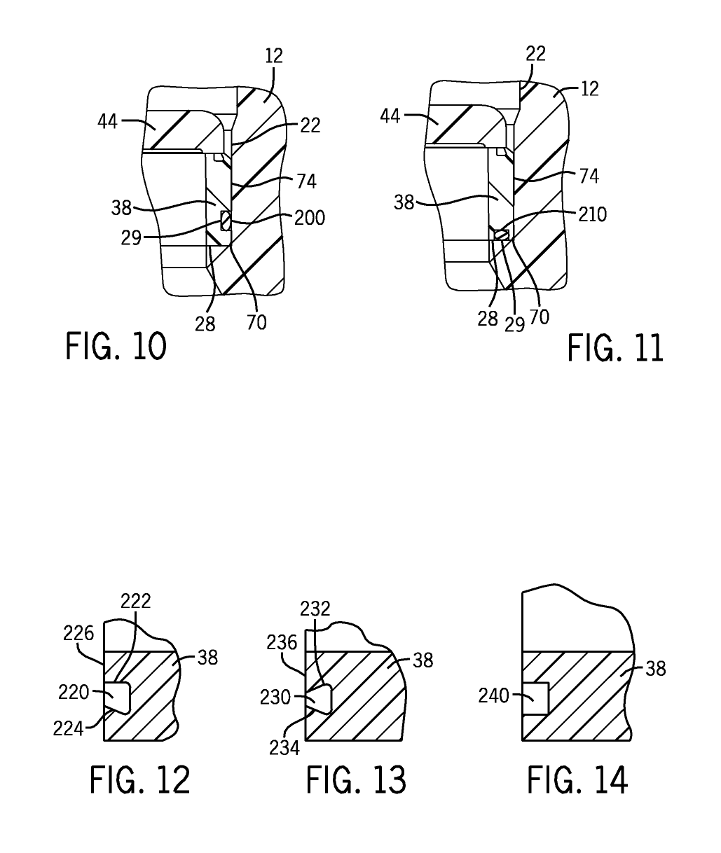

FIG. 10 is a sectional view within line 10-10 of FIG. 1, illustrating an embodiment of a seal interface between the housing 12 and the annular support 38. As illustrated in FIG. 1, the interior surface 22 of the housing 12 defines an aperture 26, which supports a gasket 29 that creates a seal between the exterior surface 74 of the annular support 38 and the interior surface 22. As illustrated in FIG. 10, instead of the aperture 26 on the interior surface 22, a gasket aperture 200 is formed in the outer surface 74 of the annular support 38. Accordingly, the gasket 29 is disposed in the annular support 38 instead of the interior surface 22 of the housing 12. In this embodiment, the gasket 29 may be installed and removed as part of the cartridge 14 as a single unit.

FIG. 11 is a sectional view within line 10-10 of FIG. 1, illustrating another embodiment of a seal interface between the housing 12 and the annular support 38. In FIG. 11, instead of aperture 26 being located in the interior surface 22 of the housing 12, an aperture 210 is formed in the front surface 70 of the annular support 38. As a result, the aperture 210 supports the gasket 29, for sealing along the annular seat contact surface 28 of the housing 12 rather then the interior surface 22. Again, the gasket 29 is part of the cartridge 14 in the illustrated embodiment, such that the gasket 29 is installed and removed along with the cartridge 14 as a single unit.

FIGS. 12, 13, and 14 are sectional views within line 12-12 of FIG. 1, illustrating seal interfaces between the annular support 38 and the check valve elements 44. As illustrated in FIGS. 1 and 2, the annular support 38 includes apertures 84 and 86, which support gaskets 88 and 90. The gaskets 88 and 90 create the seal between the elements 44 and the annular support 38. FIG. 12 illustrates an embodiment of the apertures 84 and 86 as a half dovetail aperture 220. The half dovetail aperture 220 expands in width as it extends into the support 38. For example, the aperture 220 has a first side 222 and a second side 224 that diverge from one another away from a surface 226. In the illustrated embodiment, the first side 222 is perpendicular to the surface 226, while the second side 224 is non-perpendicular to the surface 226. In this manner, the aperture 220 is able to self-retain (e.g., compress or block removal of) the gasket (e.g., 88 or 90) disposed in the aperture 220.

FIG. 13 illustrates a dovetail shaped aperture 230. The dovetail shaped aperture likewise expands in width as it extends into the support 38. For example, the aperture 230 has a first side 232 and a second side 234 that diverge from one another away from a surface 226. In the illustrated embodiment, the two sides 232 and 234 are non-perpendicular to the surface 236. In this manner, the aperture 230 is able to self-retain (e.g., compress or block removal of) the gasket (e.g., 88 or 90) disposed in the aperture 230. FIG. 14 illustrates another possible aperture shape. In particular, FIG. 14 illustrates a rectangular aperture 240 that receives gasket 84 or 86. While three aperture shapes 220, 230, and 240 are illustrated in FIGS. 12, 13, and 14, other aperture shapes are possible including circular, oval, and rectangular, among others.

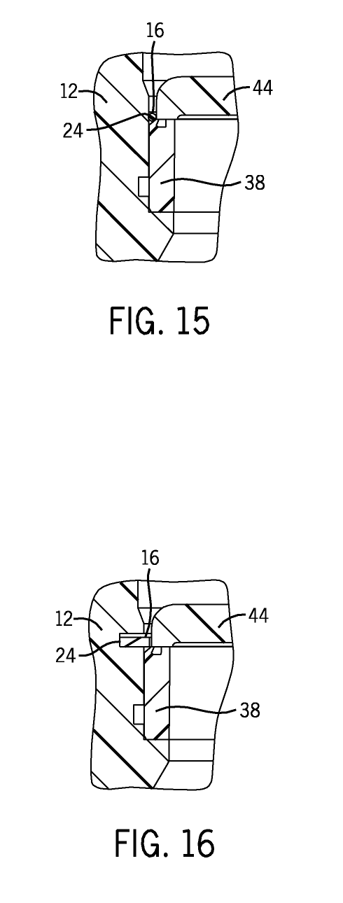

FIGS. 15 and 16 are sectional views within line 15-15 of FIG. 1, illustrating embodiments of the retainer 16 that axially holds the cartridge 14 in the housing 12. As illustrated, FIGS. 15 and 16 illustrate different cross-sections for retainer 16. For example, FIG. 15 illustrates a circular shaped cross-section of the retainer 16, while FIG. 16 illustrates a rectangular shaped cross-section of the retainer 16. In either embodiment, the retainer 16 may be a complete ring or a partial ring, such as a C-shape. The retainer 16 is configured to compress and then expand into the retainer aperture 24 during installation, thereby blocking axial movement of the cartridge 14 relative to the housing 12. In other embodiments, the retainer 16 may have another cross-section, such as oval, square, dovetail, T-shaped, or any other suitable shape.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a check valve, comprising:
a housing comprising a fluid passage along a housing axis;
a check valve cartridge disposed in the fluid passage; and
a retainer that limits axial movement of the check valve cartridge in the fluid passage, wherein the retainer allows rotational movement of the check valve cartridge.

2. The system of claim 1, wherein the check valve cartridge comprises at least one check valve element coupled to an annular support, and the at least one check valve element is configured to open and close relative to the annular support.

3. The system of claim 2, wherein the annular support comprises an annular seat that seals the annular support to an inner surface of the housing.

4. The system of claim 2, wherein the check valve cartridge comprises a first mounting insert disposed in a first mounting groove along the annular support, and the first mounting insert couples the at least one check valve element to the annular support.

5. The system of claim 4, wherein the housing or the retainer blocks removal of the first mounting insert from the first mounting groove while the check valve cartridge is retained in the fluid passage.

6. The system of claim 4, wherein the first mounting groove extends radially into the annular support, and the first mounting insert is configured to insert radially into and remove radially from the first mounting groove.

7. The system of claim 4, wherein the first mounting insert comprises a first hinge support of the at least one check valve element.

8. The system of claim 7, wherein the check valve cartridge comprises a second mounting insert disposed in a second mounting groove along the annular support opposite from the first mounting groove, the second mounting insert couples the at least one check valve element to the annular support, and the second mounting insert comprises a second hinge support of the at least one check valve element.

9. The system of claim 8, wherein the at least one check valve element comprises a hinge shaft, a first plate rotatably coupled to the hinge shaft, and a second plate rotatably coupled to the hinge shaft, wherein the hinge shaft is coupled to the first and second hinge supports.

10. The system of claim 9, wherein the at least one check valve element comprises at least one spring configured to bias the first and second plates toward a closed position relative to the annular support.

11. The system of claim 1, wherein the check valve cartridge is axially captured between the retainer and an inner lip of the housing.

12. The system of claim 1, wherein the retainer comprises a retainer ring.

13. A system, comprising:
a check valve cartridge, comprising:
an annular support comprising an annular seat; and
at least one check valve element coupled to the annular support, wherein the check valve cartridge is configured to rotate within a fluid passage to reduce turbulent flow.

14. The system of claim 13, wherein the check valve cartridge is configured to rotate within the fluid passage while axially captured to block axial movement of the check valve cartridge.

15. The system of claim 13, wherein the check valve cartridge is configured to be installed and removed from the fluid passage as a single unit.

16. The system of claim 13, wherein the check valve cartridge is configured to mount within the fluid passage without any threaded fastener.

17. The system of claim 13, wherein the at least one check valve element comprises a hinge shaft, a first plate rotatably coupled to the hinge shaft, a second plate rotatably coupled to the hinge shaft, and at least one spring configured to bias the first and second plates toward a closed position relative to the annular support, wherein the check valve cartridge comprises a first mounting insert disposed in a first mounting groove along the annular seat, and a second mounting insert disposed in a second mounting groove along the annular seat opposite from the first mounting groove, wherein the first and second mounting inserts support the hinge shaft, and the first and second mounting inserts are configured to insert radially into and remove radially from the respective first and second mounting grooves.

18. A system, comprising:
a check valve cartridge, comprising:
an annular support comprising an annular seat; and
at least one check valve element coupled to the annular support, wherein the check valve cartridge is configured to be installed and removed from a fluid passage as a single unit.

19. The system of claim 18, comprising a check valve having the check valve cartridge axially captured in the fluid passage of a housing.

20. The system of claim 18, wherein the check valve cartridge comprises a first mounting insert disposed in a first mounting groove along the annular seat, and a second mounting insert disposed in a second mounting groove along the annular seat opposite from the first mounting groove, wherein the first and second mounting inserts support the at least one check valve element, the first and second mounting inserts are configured to insert radially into and remove radially from the respective first and second mounting grooves, and the first and second mounting inserts are configured to be retained in the respective first and second mounting grooves by a wall of the fluid passage.
